(19) United States
(12) Patent Application Publication
(10) Pub. No.: US 2021/0224831 A1
(43) Pub. Date: Jul. 22, 2021

(54) METHODS AND APPARATUS FOR ANALYZING AN INTERNET AUDIENCE

(71) Applicant: The Nielsen Company (US), LLC, New York, NY (US)

(72) Inventor: Peeyush Bajpai, New Delhi (IN)

(21) Appl. No.: 17/153,811

(22) Filed: Jan. 20, 2021

(30) Foreign Application Priority Data
Jan. 20, 2020 (IN) 202011002400

(51) Int. Cl. G06Q 30/02

(52) U.S. Cl. CPC G06Q 30/0201; G06Q 30/0242

(57) ABSTRACT

Methods and apparatus for analyzing an internet audience are disclosed. An example method includes: obtaining, by executing an instruction with a processor, measurements corresponding to a user in a geographic area; generating, by executing an instruction with a processor, a plurality of metrics corresponding to the measurements for the user in the geographic area, the plurality of metrics corresponding to an Internet maturity; assigning, by executing an instruction with a processor, a weight to the plurality of metrics; determining, by executing an instruction with a processor, a first Internet maturity index for the user of the geographic area; and determining, by executing an instruction with a processor, an Internet maturity index for the geographic area based on combining the first Internet maturity index with other Internet maturity indices for other users in the geographic area, the Internet maturity index to be utilized to operate audience measurement computing systems.

### RELATED APPLICATIONS

This patent claims the benefit of and priority to Indian Provisional Patent Application Serial No. 202011002400, filed on Jan. 20, 2020. The entirety of Indian Provisional Patent Application Serial No. 202011002400 is incorporated herein by reference in its entirety.

### FIELD OF THE DISCLOSURE

This disclosure relates generally to audience measurement, and, more particularly, to methods and apparatus for analyzing an internet audience.

### BACKGROUND

In recent years, methods of accessing Internet content have evolved. For example, Internet content was formerly primarily accessed via computer systems such as desktop and laptop computers. Recently, mobile devices have been introduced that allow users to request and view internet content in a variety of settings. Some companies wish to determine where new markets are emerging and/or developing based on Internet access available in a market.

### BRIEF DESCRIPTION OF THE DRAWINGS

FIG. 1 is a block diagram of an example maturity index determiner constructed in accordance with the teachings of this disclosure to estimate a maturity index for a geographic area.

FIG. 2 is a block diagram of an example implementation of the example maturity index engine of FIG. 1.

FIG. 3 is a flowchart representative of example machine readable instructions which may be executed to implement the example maturity index determiner of FIG. 1 to estimate a maturity index in a geographic area.

FIG. 4 is a block diagram of an example processing platform structured to execute the instructions of FIG. 3 to implement the maturity index engine of FIGS. 1 and/or 2.

FIG. 5 is a block diagram of an example software distribution platform to distribute software (e.g., software corresponding to the example computer readable instructions of FIGS. 3 and/or 4) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

In light of the increase in usage of online services such as Internet services, there is an interest in developing a measure that reflects online usage at a granular level. Furthermore, there is an interest in developing measures that enable advertisements, media providers, marketers, retailers, service providers, etc. to prioritize their efforts as they relate to online activities.

Examples disclosed herein estimate an Internet maturity index that belongs to one or more specified consumer segments within a geographic area of interest. To generate such an estimate, some disclosed examples gather data indicating behavior associated with the Internet from multiple data sources. In some such examples, these data also include geospatial, or location-based, components. That is, the data are related to a particular location or area. Example data sources include databases of Mobile and Internet Service Providers, Mobile Application owners, Media providers, handset providers, Network providers, marketing and advertising firms, data measurement and market research firms, activity databases, surveys, points of interest, databases of store information and/or sales information, and/or databases of economic information, among others. In some examples, data sources are derived from the same greater geographic region as the geographic area(s) for which classification is desired, in a similar geographic region as the geographic area(s) for which classification is desired, and/or anywhere such data sources are available.

Examples disclosed herein analyze the measurements from the data sources to generate a plurality of weights corresponding to a plurality of metrics corresponding to the measurements. Examples disclosed herein determine an Internet maturity index for the geographic area based on the plurality of weights. In some examples, the Internet maturity index is utilized to operate an audience measurement computing system. For example, the Internet maturity index may be utilized to eliminate data to be processed by the audience measurement computing system, thereby improving the operation of the audience measurement computing system.

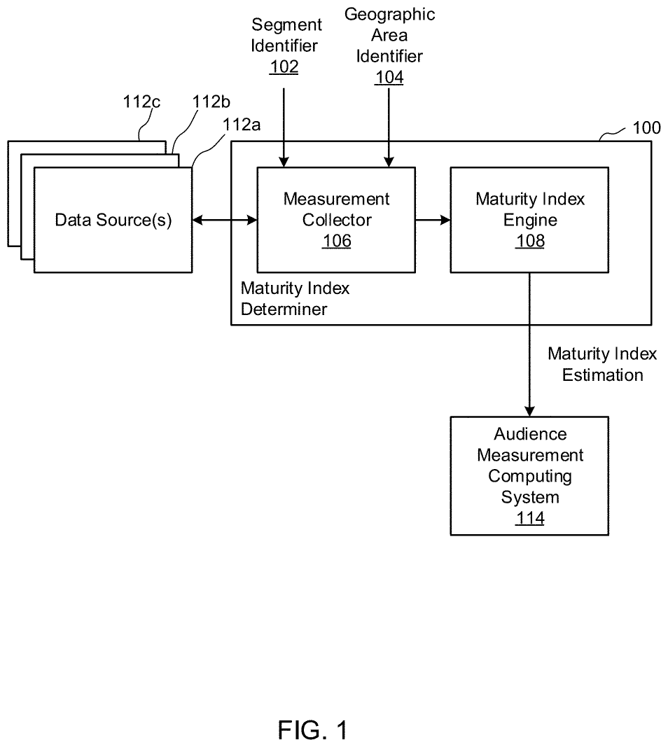

FIG. 1 is a block diagram of an example maturity index determiner 100 to estimate a maturity index (e.g., an Internet maturity index) for a geographic area. Generally, the example maturity index determiner 100 of FIG. 1 receives an identification of a consumer segment identifier 102 and an identification of a geographic area 104. The maturity index determiner 100 measures characteristics of the corresponding geographic area, and estimates the corresponding maturity index within the geographic area (e.g., the population of persons within the consumer segment corresponding to the input consumer segment identifier 102) using the measured characteristics and a relationship between the characteristics and the consumer segment. The example maturity index determiner 100 of FIG. 1 includes a measurement collector 106, and a maturity index engine 108. The structure and operation of an example implementation of the example maturity index determiner 100 are described in more detail below.

The example measurement collector 106 of FIG. 1 collects measurements of characteristics for geographic area(s) from one or more data sources 112a-c. In some examples, the measurement collector 106 obtains measurements corresponding to a user in the geographic area. In some examples, the data sources 112a-c include at least one of the following: Mobile and Internet Service Providers, Mobile Application owners, Media providers, handset providers, Network providers, marketing and advertising firms, data measurement and market research firms, activity databases, surveys, points of interest, databases of store information and/or sales information, and/or databases of economic information, among others. In some examples, the Mobile and Internet Service Providers (ISP) provides measurements of users such as device details (model, brand and make), OS version, data and voice usage, etc. In some examples, the Mobile Application owners (e.g., including crowd sourcing-based offerings) provide measurements corresponding to device details, app usage, and other mobile usage. In some examples, Media providers provide measurements of usage of specific content and related information. In some examples, Handset providers provide measurements corresponding to their handset users. In some examples, Network providers (e.g., tower companies, switches, etc.) provide measurements corresponding to usage of the infrastructure. In some examples, Marketing and Advertising firms (e.g., including data management platforms (DMP), demand side platforms (DSP), etc.) provide measurements from multiple sources to target users and also capture information on advertisements displayed, etc. In some examples, Data measurement and market research firms provide measurements both actively and passively on internet usage and users.

In some examples, the measurement collector 106 collects the following information in Table 1 for each individual user in a geographic area of interest from the data sources 112a-c.

TABLE 1

| Categories | Measurements |
|---|---|
| Internet | Network signal by type (2G, 3G, 4G, VOLTE, 5G); Presence of |
| | Cell towers, Presence of Broadband; |
| Smartphone | Number of Smartphone users; Type, make and model of devices, |
| | Type and version of OS, |
| Communication | Access and usage of Gmail, Whats app, |
| Content | Access and use of Youtube, wikipedia, google maps, google, |
| | specific local search engine, specific text, audio and video content |
| | sites in a given geography |
| Social Media/ | Access and use of facebook, twitter, Instagram, tiktok, sharechat, |
| Interactive | and specific social media apps in a given geography |
| Financial Transaction | Access and use of banking apps, doing financial transaction, credit |
| | and debit cards, digital wallets, investment apps |
| Utility/Productivity | Access and use of utility apps such as Microsoft office, notes, |
| | photos, pdf, cleaners, |
| E-Commerce | Access and use of e-commerce apps such as amazon, Alibaba, |
| | Flipkart, etc . . . |

In some examples, the measurement collector 106 collects first measurements of a set of characteristics for first areas. The characteristics measured by the measurement collector 106 are selected based on an association between collectable data and the specified consumer segment identifier 102. The example measurement collector 106 may collect measurements from multiple areas in which the demand for the consumer segment corresponding to the consumer segment identifier 102 is known. Multiple areas are then used to create and/or refine the maturity index estimation.

The example measurement collector 106 provides collected measurements of the characteristics to the maturity index engine 108. The maturity index engine 108 of FIG. 1 determines an internet maturity index estimate based on the collected measurements from the measurement collector 106. For example, the maturity index engine 108 generates a plurality of metrics corresponding to the measurements for the user in the geographic area. In some examples, the plurality of metrics corresponding to an Internet maturity. For example, the metrics include at least one of i) measure of Internet awareness, ii) measure of Internet accessibility, and iii) measures of Internet usage. In some examples, the maturity index engine 108 generates the plurality of metrics by analyzing a set of categories common to the metrics, the categories including at least one of Internet, smartphone, communication, content, social media interaction, financial transactions, utility, and e-commerce. In some examples, the categories are one or more of the categories listed in Table 1 above. The example maturity index engine 108 assigns a weight to each of the plurality of metrics. For example, the maturity index engine 108 computes a weighted average for each of the metrics. The example maturity index engine 108 determines a first Internet maturity index for the user of the geographic area by combining the weighted average for each of the metrics and normalizing the first Internet maturity index. For example, normalizing the first Internet maturity index includes normalizing the first Internet maturity index to a common scale. For example, the common scale may be 0-100, 0 being no Internet maturity (e.g., no internet access, no computing devices, etc.) and 100 being the highest Internet maturity (e.g., multiple sources of access to the internet, high Internet usage, etc.). In some examples, the maturity index engine 108 determines an Internet maturity index for the geographic area based on combining the first Internet maturity index with other Internet maturity indices for other users in the geographic area. For example, the maturity index engine 108 determines the internet maturity index for the geographic area by summing the normalized first Internet maturity index with other normalized Internet maturity indices in the geographic area, and averaging the summation to determine an aggregate Internet maturity index for the geographic area. In some examples, the maturity index engine 108 transmits the maturity index estimation to an audience measurement computing system 114 to be utilized in further processing. For example, the Internet maturity index may be utilized by the audience measurement computing system 114 to eliminate data to be processed by the audience measurement computing system 114, thereby improving the operation of the audience measurement computing system 114.

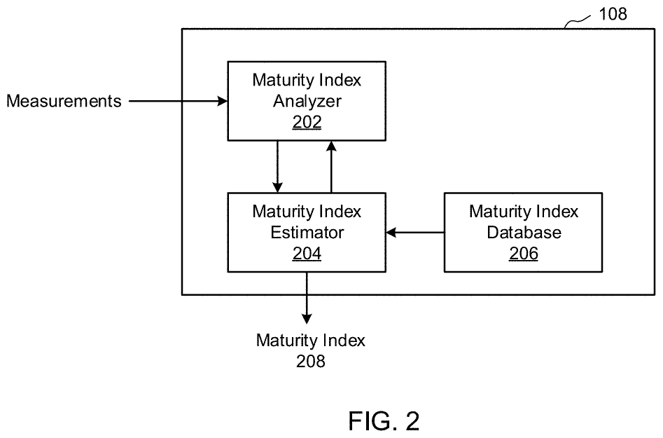

FIG. 2 is a block diagram of an example implementation of the maturity index engine 108 of FIG. 1. As mentioned above, the example maturity index engine 108 receives measurements from the measurement collector 106. The example maturity index engine 108 of FIG. 2 outputs a maturity index 208, which can be utilized to improve the operation of the audience measurement computing system 114. In the illustrated example of FIG. 2, the maturity index engine 108 includes an example maturity index analyzer 202, an example maturity index estimator 204, and an example maturity index database 206.

In the illustrated example of FIG. 2, the maturity index analyzer 202 generates a plurality of metrics corresponding to the measurements for the user in the geographic area. In some examples, the plurality of metrics corresponding to an Internet maturity. For example, the metrics include at least one of i) measure of Internet awareness, ii) measure of Internet accessibility, and iii) measures of Internet usage. In some examples, the maturity index analyzer 202 generates the plurality of metrics by analyzing a set of categories common to the metrics, the categories including at least one of Internet, smartphone, communication, content, social media interaction, financial transactions, utility, and e-commerce. In some examples, the categories are one or more of the categories listed in Table 1 above. In some examples, the maturity index analyzer 202 generates Table 2.

TABLE 2

| Categories | Awareness | Access | Usage |
|---|---|---|---|
| Internet | Yes/No | Have/Do not | Never/Sometime/ |
| | | Have | Regular |
| Smartphone | Yes/No | Have/Do not | Never/Sometime/ |
| | | Have | Regular |
| Communication | Yes/No | Have/Do not | Never/Sometime/ |
| | | Have | Regular |
| Content | Yes/No | Have/Do not | Never/Sometime/ |
| | | Have | Regular |
| Social Media/ | Yes/No | Have/Do not | Never/Sometime/ |
| Interactive | | Have | Regular |
| Financial | Yes/No | Have/Do not | Never/Sometime/ |
| Transaction | | Have | Regular |
| E-Commerce | Yes/No | Have/Do not | Never/Sometime/ |
| | | Have | Regular |

In some examples, the maturity index analyzer 202 populates the table based on the measurements from the measurement collector 106. For example, the maturity index analyzer 202 makes a determination regarding each category and metric by populating a response regarding the measurements from the measurement collector 106. In some examples, awareness corresponds to whether a consumer heard of the Internet or one of the specific usages, access corresponds to whether a consumer has access to Internet or any of the applications (e.g., access can be measured by the presence of applications), and usage corresponds to how a consumer uses the Internet (e.g., usage can be measured by clicks, views, time spent, data usage, posts and number of transactions). In some examples, the type of usage depends on the usage type being looked at and from application to application.

In some examples, the maturity index analyzer 202 generates Table 3.

TABLE 3

| Categories | Availability | Accessibility | Usability |
|---|---|---|---|
| Internet | Available/ | Have/Do not | Never/ |
| | Not available | Have | Sometime/ |
| | | | Regular |
| Smartphone | Available/ | Have/Do not | Never/ |
| | Not available | Have | Sometime/ |
| | | | Regular |
| Communication | Available/ | Have/Do not | Never/ |
| | Not available | Have | Sometime/ |
| | | | Regular |
| Content | Available/ | Have/Do not | Never/ |
| | Not available | Have | Sometime/ |
| | | | Regular |
| Social Media/ | Available/ | Have/Do not | Never/ |
| Interactive | Not available | Have | Sometime/ |
| | | | Regular |
| Financial | Available/ | Have/Do not | Never/ |
| Transaction | Not available | Have | Sometime/ |
| | | | Regular |
| Utility/ | Available/ | Have/Do not | Never/ |
| Productivity | Not available | Have | Sometime/ |
| | | | Regular |
| E-Commerce | Available/ | Have/Do not | Never/ |
| | Not available | Have | Sometime/ |
| | | | Regular |

In some examples, the maturity index analyzer 202 populates the table based on the measurements from the measurement collector 106. For example, the maturity index analyzer 202 makes a determination regarding each category and metric by populating a response regarding the measurements from the measurement collector 106. In some examples, Availability corresponds to a level of connectivity (Broadband, Network, and Signal), Accessibility corresponds to incidence of smartphones (device and operator), and Usability corresponds to incidence on the usage of applications. In some examples, the applications covered include: Communication, Content, Social Media, Utility, Payment, and E-Commerce.

In some examples, the maturity index analyzer 202 makes a determination for each category based on the geographic area identifier 104. For example, one geographic area may not have access to a particular utility or communication protocol and the maturity index analyzer 202 can modify the maturity index estimate based on such availability.

In the illustrated example, the maturity index analyzer 202 assigns a weight to each of the plurality of metrics. For example, the maturity index analyzer 202 computes a weighted average for each of the metrics illustrated in Table 2. For example, the maturity index analyzer 202 may determine that a particular user in a particular geographic area may be aware of the internet, have access to the internet and may use the internet regularly. In some examples, the maturity index analyzer 202 may determine that the Internet category for this user is a 5 (e.g., a value of 1 associated with a “yes,” a value of 1 associated with a “have,” and a value of 3 associated with “regular.”). However, any numerical value or weighting structure may be used to compute a weighted average for the metrics. In some examples, the maturity index analyzer 202 may determine that each category received a value of 5, indicating that the user has a high maturity index. In some examples, the maturity index analyzer 202 may determine that the weighted average for this user is 40 (e.g., combining each categories weight). In some examples, only a particular category may be of interest. As such, the maturity index analyzer 202 may determine a weighted average for the category of Internet, resulting in a value of 5 for this example.

The maturity index estimator 204 of the illustrated example determines a first Internet maturity index for the user of the geographic area by combining the weighted average for each of the metrics and normalizing the first Internet maturity index. For example, the maturity index estimator 204 normalizes the first Internet maturity index by normalizing the first Internet maturity index to a common scale. For example, the common scale may be 0-100, 0 being no Internet maturity (e.g., no internet access, no computing devices, etc.) and 100 being the highest Internet maturity (e.g., multiple sources of access to the internet, high Internet usage, etc.). In some examples, the maturity index estimator 204 may determine that a value of 40 normalizes to a value of 100. In some examples, the maturity index estimator 204 may determine that a value of 5 for the category Internet normalizes to a value of 100. In some examples, the maturity index estimator 204 stores the first Internet maturity index in the maturity index database 206 with a corresponding geographic area identifier 104.

In some examples, the maturity index estimator 204 determines an Internet maturity index for the geographic area (e.g., the geographic area identifier 104) based on combining the first Internet maturity index with other Internet maturity indices for other users in the geographic area stored in the maturity index database 206. For example, the maturity index estimator 204 determines the internet maturity index for the geographic area by summing the normalized first Internet maturity index with other normalized Internet maturity indices in the geographic area, and averaging the summation to determine an aggregate Internet maturity index for the geographic area. For example, the first internet maturity index may have a value of 100, and 1,999 other maturity index values for a given geographic area may average to a normalized maturity index of 82. The maturity index estimator 204 of the illustrated example adds the first internet maturity index to the other 1,999 maturity index values and computes a new maturity index for the geographic area. In some examples, the maturity index estimator 204 determines a maturity index value for a single user. In some examples, the maturity index estimator 204 transmits the maturity index 208 to an audience measurement computing system 114 to be utilized in further processing. For example, the Internet maturity index 208 may be utilized by the audience measurement computing system 114 to eliminate data to be processed by the audience measurement computing system 114, thereby improving the operation of the audience measurement computing system 114.

While an example manner of implementing the maturity index engine 108 of FIG. 1 is illustrated in FIG. 2, one or more of the elements, processes and/or devices illustrated in FIG. 2 may be combined, divided, re-arranged, omitted, eliminated and/or implemented in any other way. Further, the example maturity index analyzer 202, the example maturity index estimator 204 and/or, more generally, the example maturity index engine 108 of FIG. 2 may be implemented by hardware, software, firmware and/or any combination of hardware, software and/or firmware. Thus, for example, any of the example maturity index analyzer 202, the example maturity index estimator 204 and/or, more generally, the example maturity index engine 108 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example maturity index analyzer 202, the example maturity index estimator 204 and/or, more generally, the example maturity index engine 108 is/are hereby expressly defined to include a non-transitory computer readable storage device or storage disk such as a memory, a digital versatile disk (DVD), a compact disk (CD), a Blu-ray disk, etc. including the software and/or firmware. Further still, the example maturity index engine 108 of FIG. 1 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

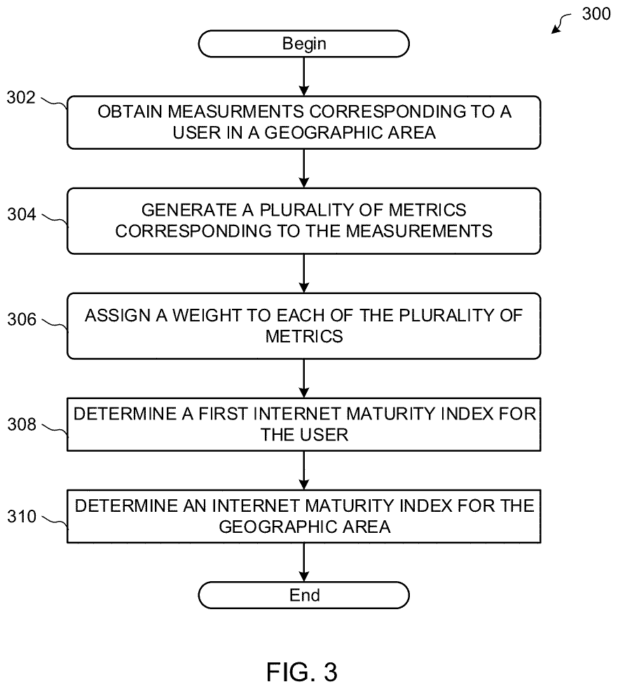

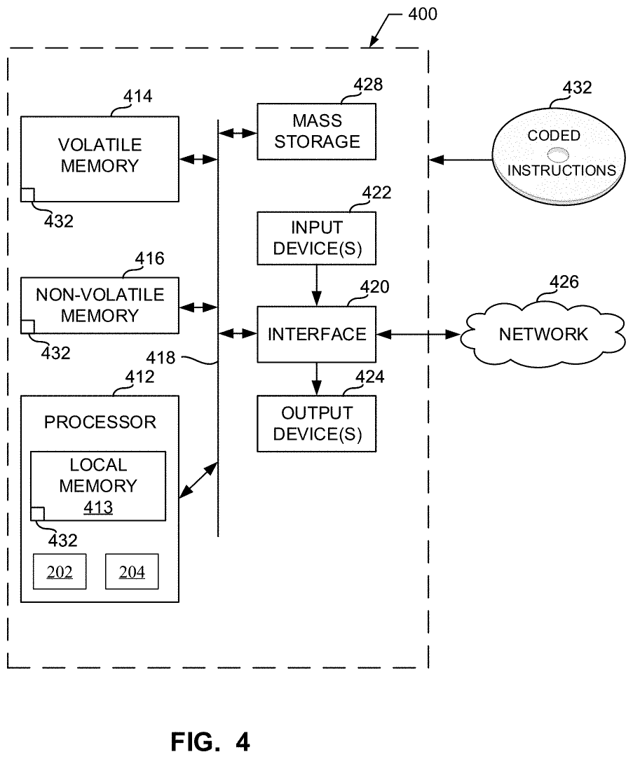

A flowchart representative of example hardware logic, machine readable instructions, hardware implemented state machines, and/or any combination thereof for implementing the maturity index engine 108 of FIG. 2 is shown in FIG. 3. The machine readable instructions may be one or more executable programs or portion(s) of an executable program for execution by a computer processor and/or processor circuitry, such as the processor 412 shown in the example processor platform 400 discussed below in connection with FIG. 4. The program may be embodied in software stored on a non-transitory computer readable storage medium such as a CD-ROM, a floppy disk, a hard drive, a DVD, a Blu-ray disk, or a memory associated with the processor 412, but the entire program and/or parts thereof could alternatively be executed by a device other than the processor 412 and/or embodied in firmware or dedicated hardware. Further, although the example program is described with reference to the flowchart illustrated in FIG. 3, many other methods of implementing the example maturity index engine 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIG. 3 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions 300 which may be executed to implement the example maturity index determiner 100 of FIG. 1 to collect measurements of a set of characteristics for a geographic area, and to determine an internet maturity index for the geographic area. The example instructions 300 of FIG. 3 may be executed to implement block 302 to obtain measurements corresponding to a user in a geographic area. For example, the measurement collector 106 obtains measurements corresponding to a user from the consumer segment identifier 102 for a geographic area(s) based on the geographic area identifier 104 from one or more data sources 112a-c.

The example maturity index engine 108 generates a plurality of metrics corresponding to the measurements (block 304). For example, the maturity index analyzer 202 generates the plurality of metrics by analyzing a set of categories common to the metrics, the categories including at least one of Internet, smartphone, communication, content, social media interaction, financial transactions, utility, and e-commerce. In some examples, the categories are one or more of the categories listed in Table 1 above.

The example maturity index engine 108 assigns a weight to each of the plurality of metrics (block 306). For example, the example maturity index analyzer 202 assigns a weight to each of the plurality of metrics by computing a weighted average for each of the metrics.

The example maturity index engine 108 determines a first Internet maturity index for the user (block 308). For example, the maturity index estimator 204 combines the weighted average for each of the metrics and normalizes the first Internet maturity index. For example, normalizing the first Internet maturity index includes normalizing the first Internet maturity index to a common scale. For example, the common scale may be 0-100, 0 being no Internet maturity (e.g., no internet access, no computing devices, etc.) and 100 being the highest Internet maturity (e.g., multiple sources of access to the internet, high Internet usage, etc.).

The example maturity index engine 108 determines an Internet maturity index for the geographic area (block 310). For example, the maturity index estimator 204 combines the first Internet maturity index with other Internet maturity indices for other users in the geographic area. For example, the maturity index estimator 204 determines the internet maturity index for the geographic area by summing the normalized first Internet maturity index with other normalized Internet maturity indices in the geographic area, and averaging the summation to determine an aggregate Internet maturity index for the geographic area. In some examples, the maturity index engine 108 transmits the maturity index estimation to an audience measurement computing system 114 to be utilized in further processing. For example, the Internet maturity index may be utilized by the audience measurement computing system 114 to eliminate data to be processed by the audience measurement computing system 114, thereby improving the operation of the audience measurement computing system 114. If no other maturity indices are to be determined, the process 300 ends.

FIG. 4 is a block diagram of an example processor platform 400 structured to execute the instructions of FIG. 3 to implement the maturity index engine 108 of FIGS. 1 and 2. The processor platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 400 of the illustrated example includes a processor 412. The processor 412 of the illustrated example is hardware. For example, the processor 412 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the maturity index analyzer 202 and the maturity index estimator 204.

The processor 412 of the illustrated example includes a local memory 413 (e.g., a cache). The processor 412 of the illustrated example is in communication with a main memory including a volatile memory 414 and a non-volatile memory 416 via a bus 418. The volatile memory 414 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 416 may be implemented by flash memory and/or any other desired type of memory device. Access to the main memory 414, 416 is controlled by a memory controller.

The processor platform 400 of the illustrated example also includes an interface circuit 420. The interface circuit 420 may be implemented by any type of interface standard, such as an Ethernet interface, a universal serial bus (USB), a Bluetooth® interface, a near field communication (NFC) interface, and/or a PCI express interface.

In the illustrated example, one or more input devices 422 are connected to the interface circuit 420. The input device(s) 422 permit(s) a user to enter data and/or commands into the processor 412. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 424 are also connected to the interface circuit 420 of the illustrated example. The output devices 424 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 420 of the illustrated example, thus, typically includes a graphics driver card, a graphics driver chip and/or a graphics driver processor.

The interface circuit 420 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 426. The communication can be via, for example, an Ethernet connection, a digital subscriber line (DSL) connection, a telephone line connection, a coaxial cable system, a satellite system, a line-of-site wireless system, a cellular telephone system, etc.

The processor platform 400 of the illustrated example also includes one or more mass storage devices 428 for storing software and/or data. Examples of such mass storage devices 428 include floppy disk drives, hard drive disks, compact disk drives, Blu-ray disk drives, redundant array of independent disks (RAID) systems, and digital versatile disk (DVD) drives.

The machine executable instructions 432 of FIG. 3 may be stored in the mass storage device 428, in the volatile memory 414, in the non-volatile memory 416, and/or on a removable non-transitory computer readable storage medium such as a CD or DVD.

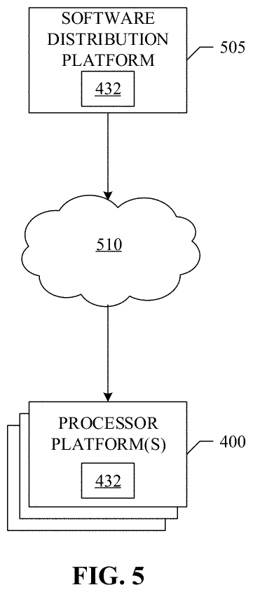

A block diagram illustrating an example software distribution platform 505 to distribute software such as the example computer readable instructions 432 of FIG. 3 to third parties is illustrated in FIG. 5. The example software distribution platform 505 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 432 of FIG. 4. The third parties may be consumers, users, retailers, OEMs, etc., who purchase and/or license the software for use and/or re-sale and/or sub-licensing. In the illustrated example, the software distribution platform 505 includes one or more servers and one or more storage devices. The storage devices store the computer readable instructions 432, which may correspond to the example computer readable instructions 300 of FIG. 3, as described above. The one or more servers of the example software distribution platform 505 are in communication with a network 510, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 432 from the software distribution platform 505. For example, the software, which may correspond to the example computer readable instructions 300 of FIG. 3, may be downloaded to the example processor platform 1000, which is to execute the computer readable instructions 432 to implement the maturity index engine 108. In some example, one or more servers of the software distribution platform 505 periodically offer, transmit, and/or force updates to the software (e.g., the example computer readable instructions 432 of FIG. 4) to ensure improvements, patches, updates, etc. are distributed and applied to the software at the end user devices.

From the foregoing, it will be appreciated that example methods, apparatus and articles of manufacture have been disclosed that determine an Internet maturity index for the geographic area based on the plurality of weights. In some examples, the Internet maturity index is utilized to operate an audience measurement computing system. For example, the Internet maturity index may be utilized to eliminate data to be processed by the audience measurement computing system, thereby improving the operation of the audience measurement computing system. The disclosed methods, apparatus and articles of manufacture improve the efficiency of using a computing device by utilizing a maturity index to eliminate data to be processed by the audience measurement computing system, thereby improving the operation of the audience measurement computing system. The disclosed methods, apparatus and articles of manufacture are accordingly directed to one or more improvement(s) in the functioning of a computer.

It is noted that this patent claims priority from Indian Provisional Patent Application Serial No. 202011002400, filed on Jan. 20, 2020, and is hereby incorporated by reference in its entirety.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. A method comprising:
obtaining, by executing an instruction with a processor, measurements corresponding to a user in a geographic area;
generating, by executing an instruction with a processor, a plurality of metrics corresponding to the measurements for the user in the geographic area, the plurality of metrics corresponding to an Internet maturity;
assigning, by executing an instruction with a processor, a weight to the plurality of metrics;
determining, by executing an instruction with a processor, a first Internet maturity index for the user of the geographic area; and
determining, by executing an instruction with a processor, an Internet maturity index for the geographic area based on combining the first Internet maturity index with other Internet maturity indices for other users in the geographic area, the Internet maturity index to be utilized to operate audience measurement computing systems.

2. The method of claim 1, wherein the measurements are obtained from at least one of i) Mobile and Internet Service Providers, ii) Mobile Application owners, iii) Media providers, iv) handset providers, v) Network providers, vi) marketing and advertising firms, and vii) data measurement and market research firms.

3. The method of claim 1, wherein the metrics include at least one of i) measure of Internet awareness, ii) measure of Internet accessibility, and iii) measures of Internet usage.

4. The method of claim 1, wherein generating the plurality of metrics includes analyzing a set of categories common to the metrics, the categories including at least one of Internet, smartphone, communication, content, social media interaction, financial transactions, utility, and e-commerce.

5. The method of claim 1, wherein assigning a weight to the plurality of metrics includes computing a weighted average for the metrics.

6. The method of claim 5, wherein determining the first Internet maturity index includes combining the weighted average for the metrics and normalizing the first Internet maturity index.

7. The method of claim 6, wherein determining the Internet maturity index for the geographic area includes summing the normalized first Internet maturity index with other normalized Internet maturity indices in the geographic area, and averaging the summation to determine an aggregate Internet maturity index for the geographic area.

8. An apparatus comprising:
a measurement collector to obtain measurements corresponding to a user in a geographic area;
a maturity index analyzer to:
generate a plurality of metrics corresponding to the measurements for the user in the geographic area, the plurality of metrics corresponding to an Internet maturity; and
assign a weight to the plurality of metrics; and
a maturity index estimator to:
determine a first Internet maturity index for the user of the geographic area; and
determine an Internet maturity index for the geographic area based on combining the first Internet maturity index with other Internet maturity indices for other users in the geographic area, the Internet maturity index to be utilized to operate audience measurement computing systems.

9. The apparatus of claim 8, wherein the measurement collector to obtain the measurements from at least one of i) Mobile and Internet Service Providers, ii) Mobile Application owners, iii) Media providers, iv) handset providers, v) Network providers, vi) marketing and advertising firms, and vii) data measurement and market research firms.

10. The apparatus of claim 8, wherein the maturity index analyzer to analyze a set of categories common to the metrics, the categories including at least one of Internet, smartphone, communication, content, social media interaction, financial transactions, utility, and e-commerce.

11. The apparatus of claim 8, wherein the maturity index analyzer to compute a weighted average for the metrics when assigning a weight to the plurality of metrics.

12. The apparatus of claim 11, wherein the maturity index estimator to combine the weighted average for the metrics and normalize the first Internet maturity index when determining the first Internet maturity index.

13. The apparatus of claim 12, wherein the maturity index estimator to sum the normalized first Internet maturity index with other normalized Internet maturity indices in the geographic area, and average the summation to determine an aggregate Internet maturity index for the geographic area when determining the Internet maturity index for the geographic area.

14. A non-transitory computer readable medium comprising instructions which, when executed, cause a processor to at least:
obtain measurements corresponding to a user in a geographic area;
generate a plurality of metrics corresponding to the measurements for the user in the geographic area, the plurality of metrics corresponding to an Internet maturity;
assign a weight to the plurality of metrics;
determine a first Internet maturity index for the user of the geographic area; and
determine an Internet maturity index for the geographic area based on combining the first Internet maturity index with other Internet maturity indices for other users in the geographic area, the Internet maturity index to be utilized to operate audience measurement computing systems.

15. The computer readable medium of claim 14, wherein the instructions are further to cause the processor to obtain the measurements from at least one of i) Mobile and Internet Service Providers, ii) Mobile Application owners, iii) Media providers, iv) handset providers, v) Network providers, vi) marketing and advertising firms, and vii) data measurement and market research firms.

16. The computer readable medium of claim 14, wherein the metrics include at least one of i) measure of Internet awareness, ii) measure of Internet accessibility, and iii) measures of Internet usage.

17. The computer readable medium of claim 14, wherein the instructions are further to cause the processor to analyze a set of categories common to the metrics, the categories including at least one of Internet, smartphone, communication, content, social media interaction, financial transactions, utility, and e-commerce.

18. The computer readable medium of claim 14, wherein the instructions are further to cause the processor to compute a weighted average for the metrics when assigning a weight to the plurality of metrics.

19. The computer readable medium of claim 18, wherein the instructions are further to cause the processor to combine the weighted average for the metrics and normalize the first Internet maturity index when determining the first Internet maturity index.

20. The computer readable medium of claim 19, wherein the instructions are further to cause the processor to sum the normalized first Internet maturity index with other normalized Internet maturity indices in the geographic area, and average the summation to determine an aggregate Internet maturity index for the geographic area when determining the Internet maturity index for the geographic area.
